(19) United States
(12) Patent Application Publication
(10) Pub. No.: US 2015/0009318 A1
(43) Pub. Date: Jan. 8, 2015

(54) DRIVING SAFETY SYSTEM AND VEHICLE USING THE SAME

(71) Applicant: HON HAI PRECISION INDUSTRY CO., LTD., New Taipei (TW)

(72) Inventor: DA-YI PENG, New Taipei (TW)

(21) Appl. No.: 14/325,297

(22) Filed: Jul. 7, 2014

(30) Foreign Application Priority Data
Jul. 5, 2013 (CN) 201310281150X

(51) Int. Cl. G06K 9/00; H04N 7/18

(52) U.S. Cl. CPC G06K 9/00818; H04N 7/183
USPC 348/119

(57) ABSTRACT

A driving safety system for a vehicle includes a housing, a camera positioned on the housing, and a controller positioned on the housing and electrically coupled to the camera. The controller includes a plurality of modules whereby the camera captures images of the scene in front of the vehicle and an image identification module identifies a traffic light state and a value of a countdown timer in real time from the captured images and sends a corresponding signal to the micro control unit, then the micro control unit will warn the driver as to the states of the traffic lights and countdown timer. A vehicle using the driving safety system is also disclosed.

### FIELD

The subject matter herein generally relates to a driving safety system.

### BACKGROUND

Traffic lights are installed at crossroads or crosswalks on roads and which indicate stop, detour, passing, and the like to passing vehicles or pedestrians by red light, green light, and yellow light. A driver of a vehicle can be checking his mobile phone, chatting with others, or doing something else when he drives a vehicle to pass through the crossroads. The driver will not drive safely if not enough attention is paid to the traffic lights.

### BRIEF DESCRIPTION OF THE DRAWINGS

Implementations of the present technology will now be described, by way of example only, with reference to the attached figures.

FIG. 1 illustrates a partial, isometric view of a vehicle having a driving safety system.

FIG. 2 illustrates an isometric view of the driving safety system.

FIG. 3 is similar to FIG. 2, but viewed from another angle.

FIG. 4 is a block diagram of an example embodiment of the driving safety system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

A driving safety system used in a vehicle including a housing, a camera, a controller. The camera is positioned on the housing for capturing images of a scene in front of the vehicle. The controller can include a micro control unit, a storage module, an image identification module, and a warning module. The micro control unit can be electrically coupled with the storage module, the image identification module, and the warning module. The micro control unit can receive the images from the camera and send the images to the storage module. The image identification module can be electrically coupled with the storage module for identifying a traffic light state and a value of a countdown timer from the images in real time. When the image identification module identifies the traffic light is red and a value of the countdown timer is less than a preset value of the image identification module, and sends a signal to the micro control unit, then the micro control unit will drive the warning module to warn a driver of the vehicle.

A driving safety system for a vehicle includes a housing, a camera positioned on the housing, and a controller positioned on the housing and electrically coupled to the camera. The controller includes a plurality of modules whereby the camera captures images of the scene in front of the vehicle and an image identification module identifies a traffic light state and a value of a countdown timer in real time from the captured images and sends a corresponding signal to the micro control unit, then the micro control unit will warn the driver as to the states of the traffic lights and countdown timer.

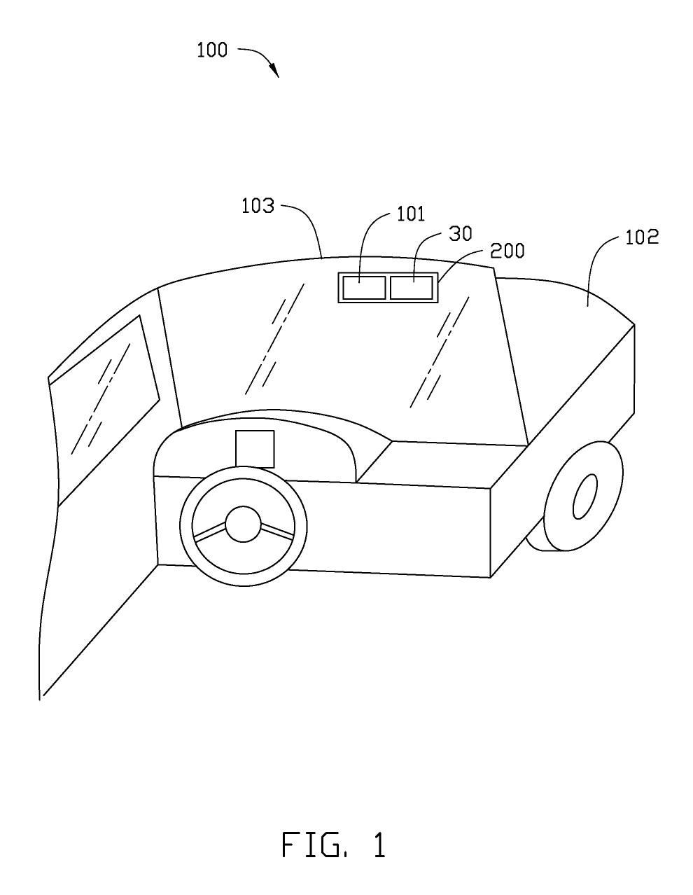

FIG. 1 illustrates a part of a vehicle having a driving safety system. The vehicle 100 can include a vehicle body 102, a front windshield 103, a rearview mirror 101, and a driving safety system 200. The front windshield 103 is assembled to the vehicle body 102. The rearview mirror 101 and the driving safety system 200 are positioned in the vehicle body 102 and are arranged adjacent to the front windshield 103. In at least one embodiment, the driving safety system 200 is an event data recorder for recording images of the scene in front of the vehicle 100. The vehicle 100 can also include other structures, such as a steering wheel, but for simplicity, they are not described here. The driving safety system 200 can be coupled to a driving control system (not shown) of the vehicle 100.

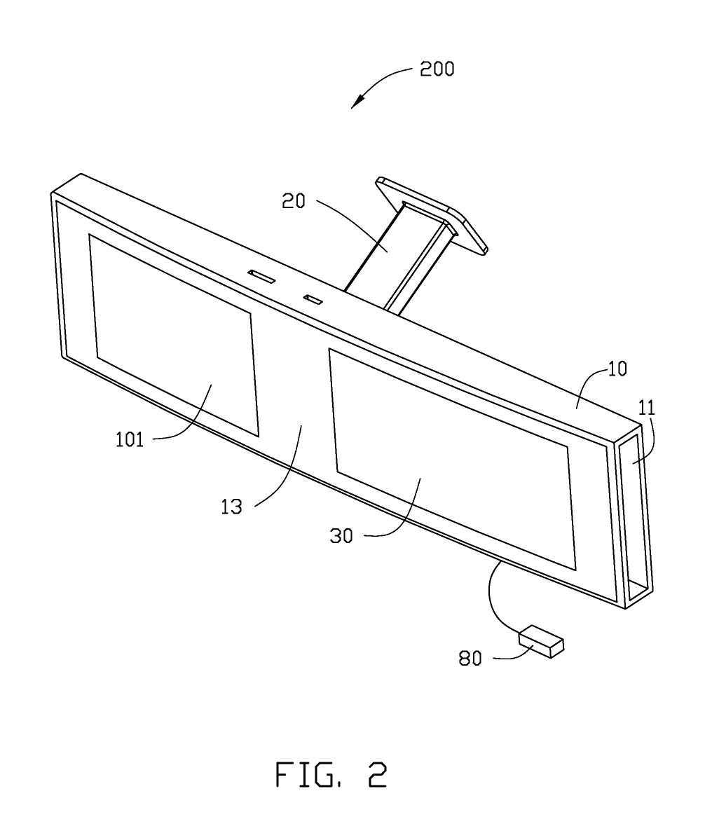

FIGS. 2-4 illustrate the driving safety system. The driving safety system 200 can include a housing 10, a support 20, a display 30, an image capturing assembly 40, a rechargeable battery 70, and a charging wire 80. The housing 10 can be substantially rectangular. The housing 10 can define a receiving space 11 and can include a first surface 13 and a second surface 15 opposite to the first surface 11. The rear view mirror 101 can be mounted on the first surface 13. The second surface 15 can be positioned adjacent to the front windshield 103. A through hole 151 can be defined in the second surface 15 to communicate with the receiving space 11.

The support 20 can be releasably coupled with the second surface 15 and the front windshield 103 for supporting the housing 10. In at least one embodiment, the support 20 can be designed as a vacuum attachment.

The display 30 can be positioned on the first surface 13 adjacent to the rearview mirror 101. The display 30 and the rearview mirror 101 can be positioned in a same plane. The display 30 can be configured for displaying warnings as to traffic lights and countdown timers (not shown). Countdown numbers corresponding to numbers shown in the countdown timers accordingly are shown in the countdown timers.

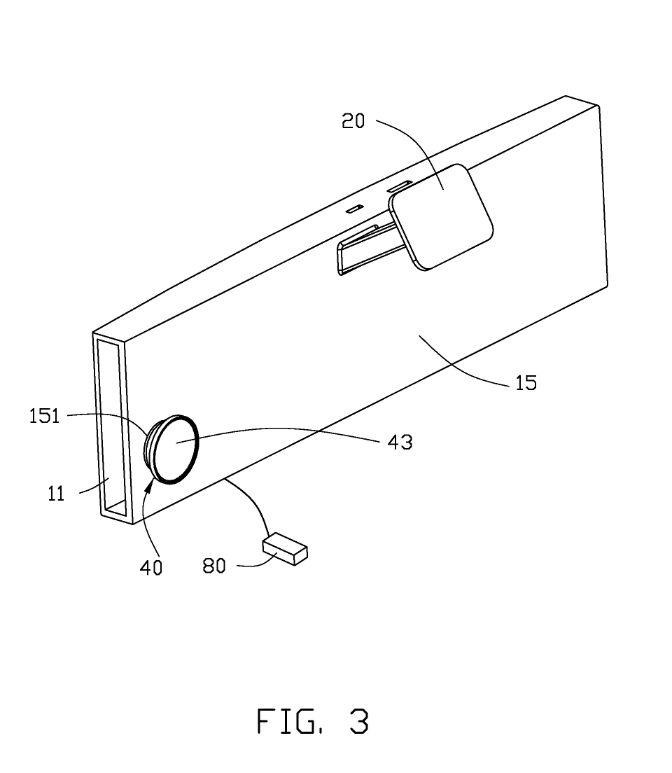

FIG. 3 illustrates the image capturing assembly 40 positioned in the through hole 151. The image capturing assembly 40 can include a camera and a wide-angle lens 43 mounted on the camera. The camera can be fixedly received in the receiving space 11 and the through hole 151. The camera can be used for capturing images of a scene in front of the vehicle 100, such as traffic lights (not shown) and countdown timers operating synchronously with the traffic lights. The wide-angle lens 43 can protrude from the through hole 151 and be exposed out the housing 10 for lateral width of images.

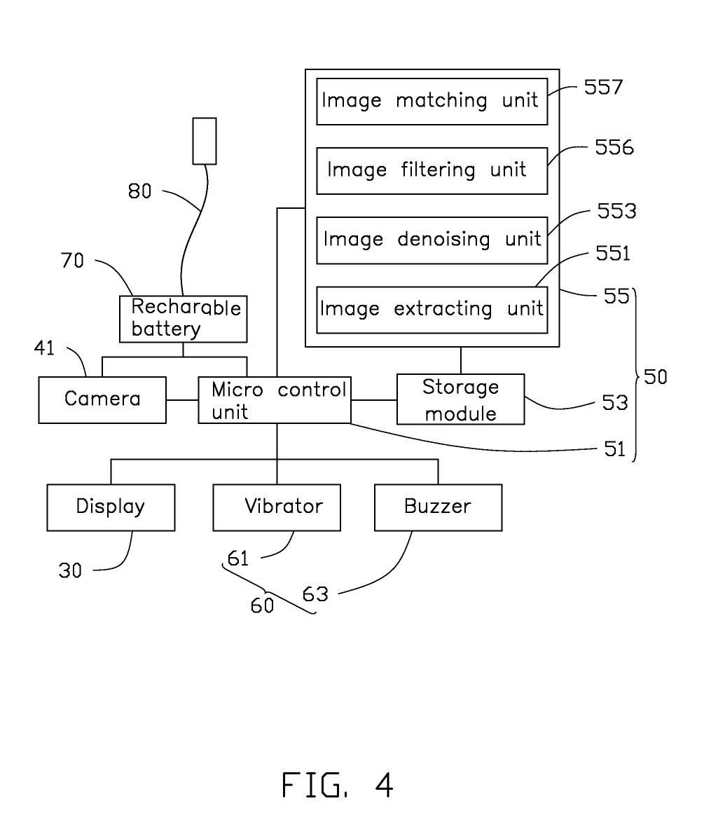

FIG. 4 illustrates a block diagram of the driving safety system. A controller 50 can be positioned in the housing and electrically coupled with the camera 41. The controller 50 can include a micro control unit 51, a storage module 53, and an image identification module 55.

The micro control unit 51 can be electrically coupled to the camera 41 for receiving images data generated by the camera 41. The micro control unit 51 can be also electrically coupled with the storage module 53 and the image identification module 55. The storage module 53 and the image identification module 55 can be electrically coupled with each other. The micro control unit 51 can transmit the images data from the camera 41 to the storage module 53 for storage.

The image identification module 55 can operate to extract particular data out of all the data received by the storage module 53. In the illustrated embodiment, the extracted particular data relates to images of the traffic lights and countdown timers. The micro control unit 51 can be electrically coupled with the driving control system of the vehicle.

The image identification module 55 can include an image extracting unit 551, an image denoising unit 553, an image filtering unit 556, and an image matching unit 557. The image extracting unit 551 can be configured for extracting the extracted particular data out of all the data received by the storage module 53. The image denoising unit 553 and the image filtering unit 556 can be configured for image denoising and filtering respectively, to improve a quality of the extracted images. The image matching unit 557 can be configured for determining state of the traffic light and the countdown timer from the processed images by the image denoising unit 553 and the image filtering unit 556, and sending a signal to the micro control unit 51. Preset values for countdown timer corresponding to different traffic lights can be initial values set in the image matching unit 557 of the image identification module 55. The preset values can be also changed via an inputting device, when the driving safety system is coupled to a process system, such as the driving control system having the inputting device. In other embodiments, the display of the driving safety system can be a touching screen for inputting. The warning assembly 60 can receive a signal from the micro control unit 51 to warn a driver of the vehicle 100.

In the illustrated embodiment, the image extracting unit 551 can extract the particular image data from the storage module 53 and convert the image to be a Hue Intensity Saturation (HIS) color space image from a Red Green Blue (RGB) color space image. Thresholds for the image segmentations can be done by the image extracting unit 551 according the RGB color space and the HIS color space in order. Thereby, colors of the images extracted by the image extracting unit 551 can be more precise and true to avoid confusion. Then, the images extracted by the image extracting unit 551 can be processed by the image denoising unit 553 by the application of morphology erosions applied twice and morphological dilations applied twice. The morphology erosions are for removing boundary points of the images to decrease image noise. The morphological dilations are for filling blanks of the extracted images, to repair the extracted images. The image filtering unit 556 filters the images after processing by the image denoising unit 553 according to shapes of the traffic lights and number of the countdown timers, via a clustering algorithm. The image matching unit 557 can generate traffic light and countdown timer modes and calculate eigenvalues for the marking of areas. The image matching unit 557 can determine state of traffic lights and a value for countdown timers when the eigenvalues for the marking of areas are greater than a preset threshold of the image matching unit 557.

The warning assembly 60 can be mounted in the receiving space 11 and electrically coupled with the micro control unit 51. The warning assembly 60 can include a vibrator 61 and a buzzer 63. The vibrator 61 and the buzzer 63 are positioned on the housing 10 and electrically coupled with the micro control unit 51.

When the traffic light is green, and a value of the countdown timer is greater than or equal to a first preset value, the micro control unit 51 will control the display 30 to flash or display a green warning signal, the vibrator 61 to vibrate, and the buzzer 63 to give out a sound indicating that the driver can keep driving. When the traffic light is yellow, the micro control unit 51 will control the display 30 to flash or display a yellow warning signal, the vibrator 61 to vibrate, and the buzzer 63 to give out a warning sound which warns the drivers to stop driving. When the traffic light is red, and a value of the countdown timer is less than the second preset value, the micro control unit 51 will control the display 30 to flash or display a green warning signal, the vibrator 61 to vibrate, and the buzzer 63 to give out a warning sound for the driver to start driving. When the traffic light is green, and a value of the countdown timer is less than the first value, the micro control unit 51 will control the display 30 to flash or display a red warning signal, the vibrator 61 to vibrate, and the buzzer 63 to give out a warning sound for the driver to stop driving. In the illustrated embodiment, the first preset value and the second preset value are both preset at 5.

The rechargeable battery 70 can be mounted in the receiving space 11 and electrically coupled with the camera 41 and the micro control unit 51.

The charging wire 80 can be detachably positioned in the housing 10 and electrically coupled with the rechargeable battery 70. Another end of the charging wire 80 can be electrically coupled with a cigar lighter (not shown) of the vehicle 100 for obtaining power.

In other embodiments, the warning signals flash or are displayed by the display 30 in a manner set by the driver. The housing can be in other shapes.

The embodiments shown and described above are only examples. Many details are often found in the art such as the other features of a vehicle body. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A driving safety system configured to operate in a vehicle, the driving safety system comprising:
a housing;
a camera positioned on the housing for capturing images of a scene in front of the vehicle;
a controller positioned on the housing and electrically coupled to the camera and comprising:
a micro control unit configured to receive captured images from the camera,
a storage module electrically coupled to the micro control unit and configured to receive the captured images from the micro control unit,
an image identification module electrically coupled to the micro control unit and the storage unit and being configured to identify a traffic light state and a value of a countdown timer from the storage images in real time,
a warning module electrically coupled to the micro control unit,
wherein the image identification module sends a signal to the micro control device upon a determination that a traffic light in an image is red and a value of the countdown timer is less than a preset value and the micro control unit sending a signal to the warning module to cause the warning module to emit a warning.

2. The driving safety system of claim 1, wherein the warning module comprises a vibrator and a buzzer, the vibrator and the buzzer are positioned on the housing and electrically coupled with the micro control unit.

3. The driving safety system of claim 1, wherein the housing comprises a first surface, the driving safety system further comprises a display mounted on the first surface and electrically coupled to the micro control unit for displaying a warning signal and final countdown numbers of the countdown timer.

4. The driving safety system of claim 1, further comprising a wide angle lens assembled to the camera for widely grabbing images being front of the vehicle.

5. The driving safety system of claim 1, further comprising a rechargeable battery electrically coupled with the camera and the micro control unit.

6. The driving safety system of claim 1, further comprising a charging wire for coupling between the rechargeable battery and a cigar lighter of the vehicle.

7. A driving safety system for a vehicle, comprising:
a housing;
a camera positioned on the housing for capturing images of a scene in front of the vehicle; and
a controller positioned on the housing and electrically coupled to the camera, the controller comprising a micro control unit, a storage module, an image identification module, and a warning module, the micro control unit electrically coupled with the storage module, the image identification module, and the warning module,
wherein the micro control unit is configured for receiving the images from the camera and sending the images to the storage module, the image identification module is electrically coupled with the storage module for identifying a traffic light state and a value of a countdown timer from the images in real time, and sending a corresponding signal to the micro control unit, then the micro control unit will drive the warning module to send out a warning signal as to the state of the traffic lights and countdown timer.

8. The driving safety system of claim 7, wherein the warning module comprises a vibrator and a buzzer, the vibrator and the buzzer are positioned on the housing and electrically coupled with the micro control unit.

9. The driving safety system of claim 7, wherein the housing comprises a first surface, the driving safety system further comprises a display mounted on the first surface and electrically coupled to the micro control unit for displaying a warning signal and final countdown numbers of the countdown timer.

10. The driving safety system of claim 7, further comprising a wide angle lens assembled to the camera for widely grabbing images being front of the vehicle.

11. The driving safety system of claim 7, further comprising a rechargeable battery electrically coupled with the camera and the micro control unit.

12. The driving safety system of claim 7, further comprising a charging wire for coupling between the rechargeable battery and a cigar lighter of the vehicle.

13. The driving safety system of claim 7, wherein the image identification module comprises an image extracting unit, an image denoising unit, an image filtering unit, and an image matching unit, the image extracting unit is configured for extracting imagines of traffic lights and countdown timer out of the full amount of data received from the storage module, the image denoising unit and the image filtering unit is configured for image denoising and filtering, and the image matching unit can be configured for determining state of the traffic light and the countdown timer from the processed images by the image denoising unit and the image filtering unit, and sending a signal to the micro control unit according to corresponding state of the traffic light and the countdown timer.

14. A vehicle comprising:
a vehicle body;
a front windshield positioned on the vehicle body; and
a driving safety system positioned in the vehicle body adjacent to the front windshield, the driving safety system comprising:
a housing;
a camera positioned on the housing for capturing images of a scene in front of the vehicle; and
a controller positioned on the housing and electrically coupled to the camera, the controller comprising a micro control unit, a storage module, an image identification module, and a warning module, the micro control unit electrically coupled with the storage module, the image identification module, and the warning module,
wherein the micro control unit is configured for receiving the images from the camera and sending the images to the storage module, the image identification module is electrically coupled with the storage module for identifying a traffic light state and a value of a countdown timer from the images in real time, and sending a corresponding signal to the micro control unit, then the micro control unit will drive the warning module to send out a warning signal as to the state of the traffic lights and countdown timer.
